(19) United States
(12) Patent Application Publication
(10) Pub. No.: US 2026/0267588 A1
(43) Pub. Date: Sep. 10, 2026

(54) TECHNIQUES FOR CAUSING PLAYBACK DEVICES TO SWITCH RADIO CONNECTIONS

(71) Applicant: Sonos Inc., Goleta, CA (US)

(72) Inventor: Cheng Lu, Malden, MA (US)

(21) Appl. No.: 19/161,517

(22) PCT Filed: Feb. 28, 2024
(86) PCT No.: PCT/US2024/017683

§ 371 Date: Sep. 2, 2025

Related U.S. Application Data
(60) Provisional application No. 63/488,030, filed on Mar. 2, 2023.

(51) Int. Cl. G06F 3/16; H04R 3/12; H04R 27/00

(52) U.S. Cl. CPC G06F 3/162; G06F 3/165; H04R 3/12; H04R 27/00; H04R 2227/005; H04R 2420/07

(57) ABSTRACT

Embodiments disclosed herein include a primary device comprising a first radio and a second radio, the radios configured to wirelessly communicate with satellite playback devices and/or to communicate with a WiFi Access Point (AP). In some embodiments, the primary device is configured to transmit a Channel Switch Announcement (CSA) message to the satellite playback devices to cause the satellite playback devices to switch communication between the first, the second radio, and/or the AP. In some embodiments, the primary device communicates audio content to the satellite playback devices using the first radio. In some embodiments, the primary device ceases communication of audio content and powers off the first radio after transmitting a CSA to cause the satellite playback devices to switch communication to the second radio or to the AP.

### FIELD OF THE DISCLOSURE

The present disclosure is related to consumer goods and, more particularly, to methods, systems, products, features, services, and other elements directed to media playback or some aspect thereof.

### BACKGROUND

Options for accessing and listening to digital audio in an out-loud setting were limited until in 2002, when Sonos, Inc. began development of a new type of playback system. Sonos then filed one of its first patent applications in 2003, entitled “Method for Synchronizing Audio Playback between Multiple Networked Devices,” and began offering its first media playback systems for sale in 2005. The SONOS Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A is a partial cutaway view of an environment having a media playback system configured in accordance with aspects of the disclosed technology.

FIG. 1B is a schematic diagram of the media playback system of FIG. 1A and one or more networks.

FIG. 1C is a block diagram of a playback device.

FIG. 1D is a block diagram of a playback device.

FIG. 1E is a block diagram of a bonded playback device.

FIG. 1F is a block diagram of a network microphone device.

FIG. 1G is a block diagram of a playback device.

FIG. 1H is a partial schematic diagram of a control device.

FIGS. 1I through 1L are schematic diagrams of corresponding media playback system zones.

FIG. 1M is a schematic diagram of media playback system areas.

FIG. 1N illustrates an example communication system that includes example switching circuitry and/or communication circuitry configurations.

FIG. 2 illustrates an example configuration that includes a home theater primary device, satellite devices, and an access point (AP).

FIG. 3 illustrates another example configuration that includes the home theater primary device, satellite devices, and AP.

FIG. 4 illustrates another example configuration that includes the home theater primary device, satellite devices, and AP.

FIG. 5 illustrates a Channel Switch Announcement (CSA) message format, configured in accordance with aspects of the disclosed technology.

FIG. 6 shows an example embodiment of a method for a primary device to cause satellite playback devices to switch radio links, in accordance with aspects of the disclosed technology.

FIG. 7 shows another example embodiment of a method for a primary device to cause satellite playback devices to switch radio links, in accordance with aspects of the disclosed technology.

FIG. 8 shows an example embodiment of a method for satellite playback devices to switch radio links, in accordance with aspects of the disclosed technology.

FIG. 9 shows another example embodiment of a method for satellite playback devices to switch radio links, in accordance with aspects of the disclosed technology.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

SONOS Inc. has a long history of innovating in the home theater space as demonstrated by the successful launch of numerous home theater and wireless audio products. For example, SONOS Inc. invented a low-latency communication scheme for wireless transmission of audio from a primary device (e.g., a home theater soundbar) to one or more satellite devices (e.g., a subwoofer, a rear surround, etc.) over a dedicated network. By employing a dedicated network, referred to herein as a fronthaul network, the audio traffic may be communicated directly to the satellite devices without the delay otherwise introduced by an intermediary hop across an Access Point (AP) (or other piece of networking equipment). The primary device may employ a first radio for communication of audio to the satellite devices over the fronthaul network, and the satellite devices may connect to this fronthaul network to receive the audio for playback. The primary device may also employ a second radio configured to communicate over a second wireless network, also referred to as a backhaul network, to connect to an AP (e.g., a user's AP in their home) so as to provide a communication path to other devices (e.g., user devices to facilitate control of the home theater system and/or cloud server(s) to obtain audio content for streaming).

Operation of the fronthaul network by the first radio consumes power whether or not audio is being played, which undesirably reduces the power efficiency of the primary device. For at least this reason, it can be useful to power off the first radio when it is not needed, for example when playback has been paused or stopped. Prior to turning off the first radio, the primary device may cause the satellites to switch from the fronthaul network to either the backhaul network or the AP network. At a subsequent point in time, when audio playback is to resume, the primary can power on the first radio and cause the satellites to switch from the backhaul network or the AP (whichever they are using) back to the fronthaul network.

Accordingly, aspects of the present disclosure relate to techniques for transitioning the satellites from being connected between the fronthaul radio, the backhaul radio, and/or an access point (AP). In some instances, the satellites may be transitioned between radios through the novel use of a channel switch announcement (CSA) message to command playback devices to switch radio connections. For example, a customized CSA extension is appended to a standard CSA message to specify the media access control (MAC) address and/or Basic Service Set Identifier (BSSID) associated with the radio to which the satellite playback device should switch. In some embodiments, a primary device (e.g., a primary playback device) may comprise a first radio configured to communicate over a first wireless network (e.g., the fronthaul network) and a second radio configured to communicate over a second wireless network (e.g., the backhaul network). The primary device may then playback audio content in synchrony with one or more satellite playback devices, at least in part by communicating the audio content to the satellite playback devices over the first wireless network. When audio playback ceases, the primary device may transmit a CSA message to the satellite playback devices over the first wireless network, the CSA message configured to cause the satellite playback devices to switch connection from the first wireless network to the second wireless network or the AP network, and then power off the first radio. In some embodiments, if the CSA message is configured to cause the satellite playback devices to switch connection from the first wireless network to the AP, the second radio, which operates the backhaul network, may also be powered down.

While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

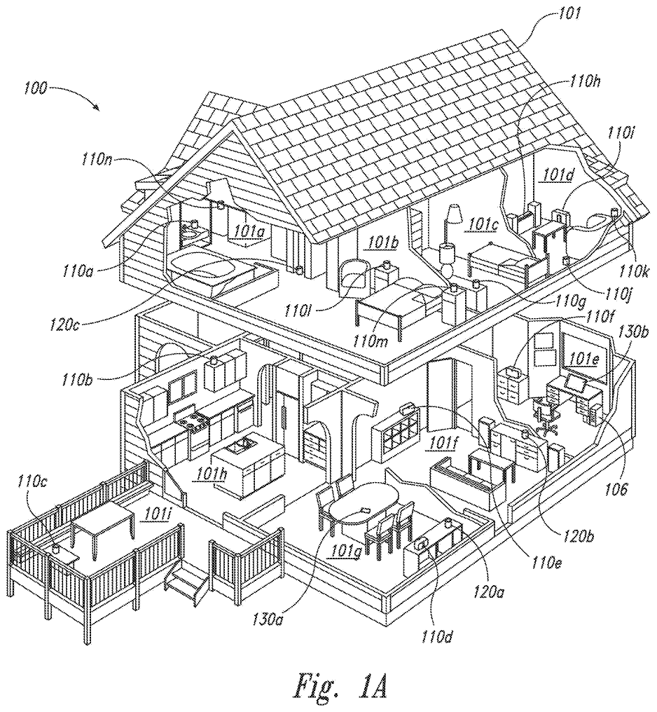

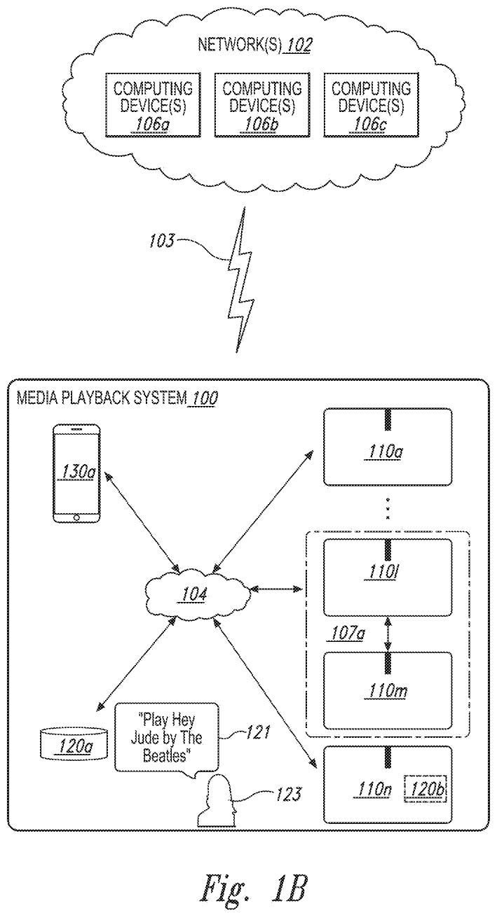

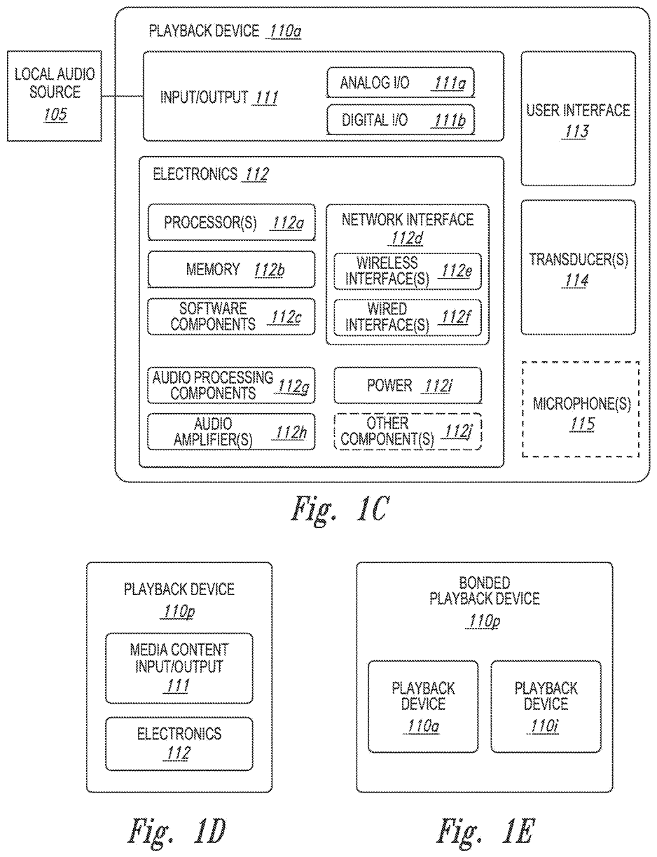

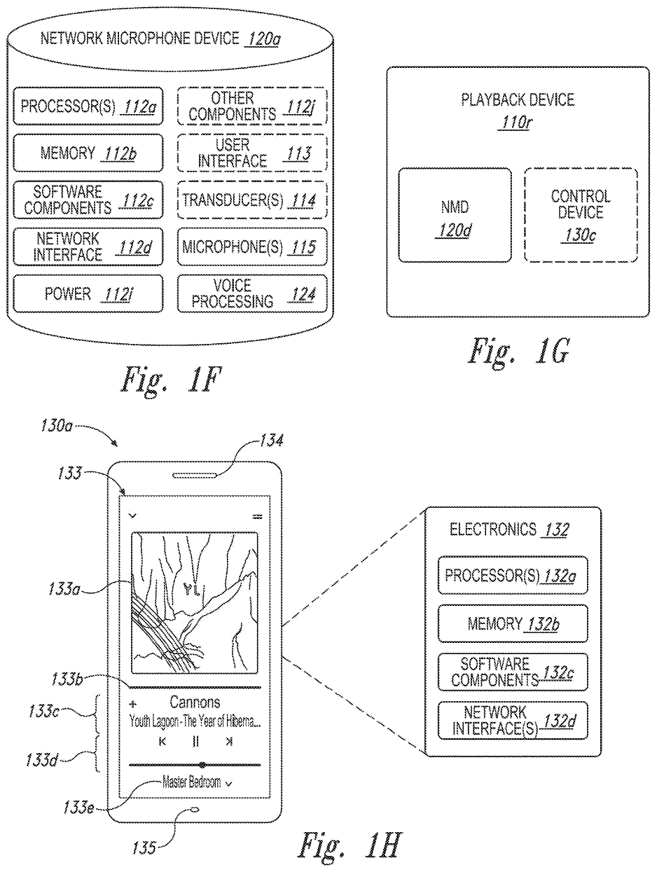

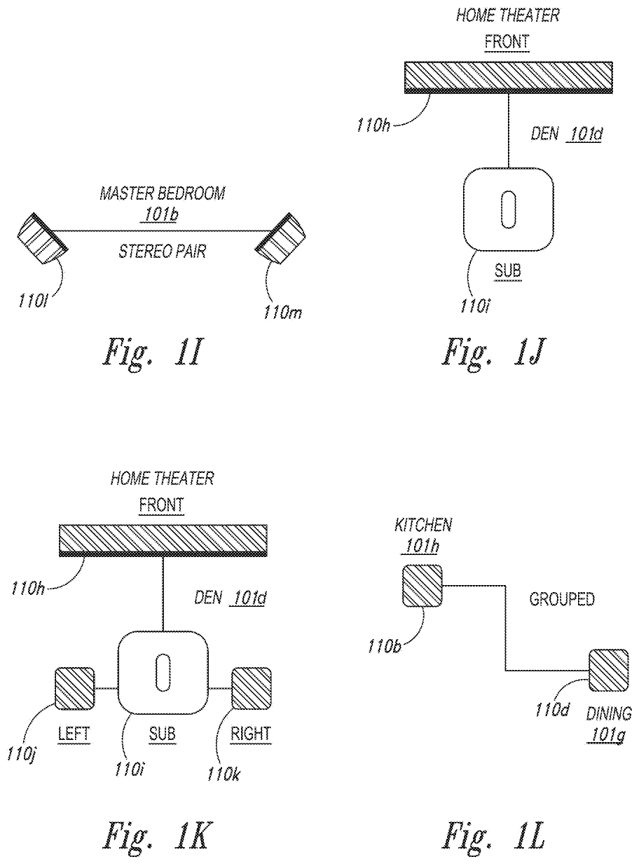

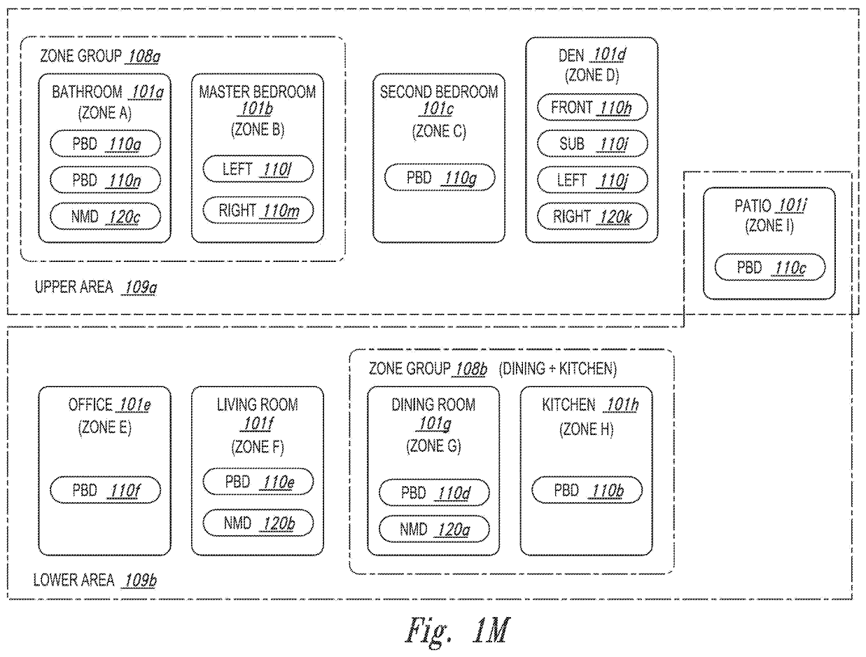

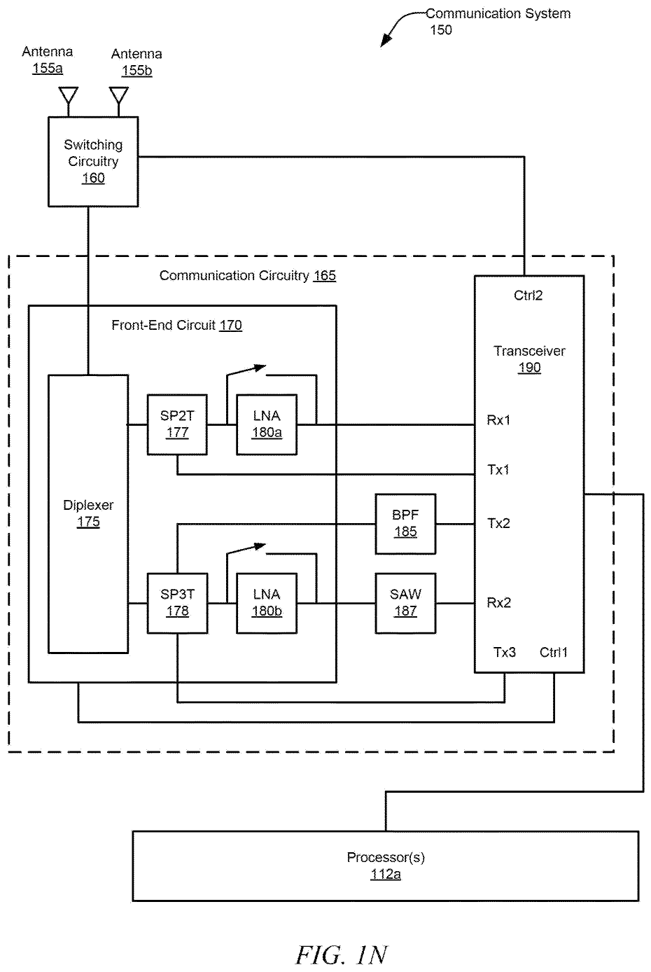

In the Figures, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles, and other features shown in the Figures are merely illustrative of particular embodiments of the disclosed technology. Accordingly, other embodiments can have other details, dimensions, angles, and features without departing from the spirit or scope of the disclosure. In addition, those of ordinary skill in the art will appreciate that further embodiments of the various disclosed technologies can be practiced without several of the details described below.

### II. Suitable Operating Environment

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices 120 (“NMDs”) (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term “NMD” (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices, etc.) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation, etc.). In some embodiments, for example, the media playback system 100 is configured to play back audio from a first playback device (e.g., the playback device 100a) in synchrony with a second playback device (e.g., the playback device 100b). Interactions between the playback devices 110, NMDs 120, and/or control devices 130 of the media playback system 100 configured in accordance with the various embodiments of the disclosure are described in greater detail below with respect to FIGS. 1B-1H.

In the illustrated embodiment of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane, etc.), multiple environments (e.g., a combination of home and vehicle environments), and/or another suitable environment where multi-zone audio may be desirable.

The media playback system 100 can comprise one or more playback zones, some of which may correspond to the rooms in the environment 101. The media playback system 100 can be established with one or more playback zones, after which additional zones may be added, or removed, to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the balcony 101i. In some aspects, a single playback zone may include multiple rooms or spaces. In certain aspects, a single room or space may include multiple playback zones.

In the illustrated embodiment of FIG. 1A, the master bathroom 101a, the second bedroom 101c, the office 101e, the living room 101f, the dining room 101g, the kitchen 101h, and the outdoor patio 101i each include one playback device 110, and the master bedroom 101b and the den 101d include a plurality of playback devices 110. In the master bedroom 101b, the playback devices 110l and 110m may be configured, for example, to play back audio content in synchrony as individual ones of playback devices 110, as a bonded playback zone, as a consolidated playback device, and/or any combination thereof. Similarly, in the den 101d, the playback devices 110h-j can be configured, for instance, to play back audio content in synchrony as individual ones of playback devices 110, as one or more bonded playback devices, and/or as one or more consolidated playback devices. Additional details regarding bonded and consolidated playback devices are described below with respect to FIGS. 1B, 1E, and 1I-1M.

In some aspects, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip hop music being played back by playback device 110c on the patio 101i. In some aspects, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Pat. No. 8,234,395 entitled, “System and method for synchronizing operations among a plurality of independently clocked digital data processing devices,” which is incorporated herein by reference in its entirety.

a. Suitable Media Playback System

FIG. 1B is a schematic diagram of the media playback system 100 and a cloud network 102. For ease of illustration, certain devices of the media playback system 100 and the cloud network 102 are omitted from FIG. 1B. One or more communication links 103 (referred to hereinafter as “the links 103”) communicatively couple the media playback system 100 and the cloud network 102.

The links 103 can comprise, for example, one or more wired networks, one or more wireless networks, one or more wide area networks (WAN), one or more local area networks (LAN), one or more personal area networks (PAN), one or more telecommunication networks (e.g., one or more Global System for Mobiles (GSM) networks, Code Division Multiple Access (CDMA) networks, Long-Term Evolution (LTE) networks, 5G communication networks, and/or other suitable data transmission protocol networks), etc. The cloud network 102 is configured to deliver media content (e.g., audio content, video content, photographs, social media content, etc.) to the media playback system 100 in response to a request transmitted from the media playback system 100 via the links 103. In some embodiments, the cloud network 102 is further configured to receive data (e.g., voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some embodiments, one or more of the computing devices 106 comprise modules of a single computer or server. In certain embodiments, one or more of the computing devices 106 comprise one or more modules, computers, and/or servers. Moreover, while the cloud network 102 is described above in the context of a single cloud network, in some embodiments the cloud network 102 comprises a plurality of cloud networks comprising communicatively coupled computing devices. Furthermore, while the cloud network 102 is shown in FIG. 1B as having three of the computing devices 106, in some embodiments, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media playback system 100. The network 104 can include, for example, a wireless network (e.g., a WiFi network, a Bluetooth, a Z-Wave network, a ZigBee, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WiFi” can refer to several different communication protocols including, for example, Institute of Electrical and Electronics Engineers (IEEE) 802.11a, 802.11b, 802.11g, 802.11n, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHz, and/or another suitable frequency.

In some embodiments, the network 104 comprises a dedicated communication network that the media playback system 100 uses to transmit messages between individual devices and/or to transmit media content to and from media content sources (e.g., one or more of the computing devices 106). In certain embodiments, the network 104 is configured to be accessible only to devices in the media playback system 100, thereby reducing interference and competition with other household devices. In other embodiments, however, the network 104 comprises an existing household or commercial facility communication network (e.g., a household or commercial facility WiFi network). In some embodiments, the links 103 and the network 104 comprise one or more of the same networks. In some aspects, for example, the links 103 and the network 104 comprise a telecommunication network (e.g., an LTE network, a 5G network, etc.). Moreover, in some embodiments, the media playback system 100 is implemented without the network 104, and devices comprising the media playback system 100 can communicate with each other, for example, via one or more direct connections, PANs, telecommunication networks, and/or other suitable communication links. The network 104 may be referred to herein as a “local communication network” to differentiate the network 104 from the cloud network 102 that couples the media playback system 100 to remote devices, such as cloud servers that host cloud services.

In some embodiments, audio content sources may be regularly added or removed from the media playback system 100. In some embodiments, for example, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length, etc.) and other associated information (e.g., URIs, URLs, etc.) for each identifiable media item found. In some embodiments, for example, the media content database is stored on one or more of the playback devices 110, network microphone devices 120, and/or control devices 130.

In the illustrated embodiment of FIG. 1B, the playback devices 110l and 110m comprise a group 107a. The playback devices 110l and 110m can be positioned in different rooms and be grouped together in the group 107a on a temporary or permanent basis based on user input received at the control device 130a and/or another control device 130 in the media playback system 100. When arranged in the group 107a, the playback devices 110l and 110m can be configured to play back the same or similar audio content in synchrony from one or more audio content sources. In certain embodiments, for example, the group 107a comprises a bonded zone in which the playback devices 110l and 110m comprise left audio and right audio channels, respectively, of multi-channel audio content, thereby producing or enhancing a stereo effect of the audio content. In some embodiments, the group 107a includes additional playback devices 110. In other embodiments, however, the media playback system 100 omits the group 107a and/or other grouped arrangements of the playback devices 110. Additional details regarding groups and other arrangements of playback devices are described in further detail below with respect to FIGS. 1I through 1M.

The media playback system 100 includes the NMDs 120a and 120b, each comprising one or more microphones configured to receive voice utterances from a user. In the illustrated embodiment of FIG. 1B, the NMD 120a is a standalone device and the NMD 120b is integrated into the playback device 110n. The NMD 120a, for example, is configured to receive voice input 121 from a user 123. In some embodiments, the NMD 120a transmits data associated with the received voice input 121 to a voice assistant service (VAS) configured to (i) process the received voice input data and (ii) facilitate one or more operations on behalf of the media playback system 100.

In some aspects, for example, the computing device 106c comprises one or more modules and/or servers of a VAS (e.g., a VAS operated by one or more of SONOS, AMAZON, GOOGLE APPLE, MICROSOFT, etc.). The computing device 106c can receive the voice input data from the NMD 120a via the network 104 and the links 103.

In response to receiving the voice input data, the computing device 106c processes the voice input data (i.e., “Play Hey Jude by The Beatles”), and determines that the processed voice input includes a command to play a song (e.g., “Hey Jude”). In some embodiments, after processing the voice input, the computing device 106c accordingly transmits commands to the media playback system 100 to play back “Hey Jude” by the Beatles from a suitable media service (e.g., via one or more of the computing devices 106) on one or more of the playback devices 110. In other embodiments, the computing device 106c may be configured to interface with media services on behalf of the media playback system 100. In such embodiments, after processing the voice input, instead of the computing device 106c transmitting commands to the media playback system 100 causing the media playback system 100 to retrieve the requested media from a suitable media service, the computing device 106c itself causes a suitable media service to provide the requested media to the media playback system 100 in accordance with the user's voice utterance.

b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises a High-Definition Multimedia Interface (HDMI) interface and/or cable. In some embodiments, the digital I/O 111b includes one or more wireless communication links comprising, for example, a radio frequency (RF), infrared, WiFi, Bluetooth, or another suitable communication link. In certain embodiments, the analog I/O 111a and the digital 111b comprise interfaces (e.g., ports, plugs, jacks, etc.) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a Bluetooth connection, an ad hoc wired or wireless communication network, and/or another suitable communication link). The local audio source 105 can comprise, for example, a mobile device (e.g., a smartphone, a tablet, a laptop computer, etc.) or another suitable audio component (e.g., a television, a desktop computer, an amplifier, a phonograph, a Blu-ray player, a memory storing digital media files, etc.). In some aspects, the local audio source 105 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 105. In other embodiments, however, the media playback system omits the local audio source 105 altogether. In some embodiments, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens, etc.), and one or more transducers 114 (referred to hereinafter as “the transducers 114”). The electronics 112 are configured to receive audio from an audio source (e.g., the local audio source 105) via the input/output 111 or one or more of the computing devices 106a-c via the network 104 (FIG. 1B), amplify the received audio, and output the amplified audio for playback via one or more of the transducers 114. In some embodiments, the playback device 110a optionally includes one or more microphones 115 (e.g., a single microphone, a plurality of microphones, a microphone array) (hereinafter referred to as “the microphones 115”). In certain embodiments, for example, the playback device 110a having one or more of the optional microphones 115 can operate as an NMD configured to receive voice input from a user and correspondingly perform one or more operations based on the received voice input.

In the illustrated embodiment of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some embodiments, the electronics 112 optionally include one or more other components 112j (e.g., one or more sensors, video displays, touchscreens, battery charging bases, etc.).

The processors 112a can comprise clock-driven computing component(s) configured to process data, and the memory 112b can comprise a computer-readable medium (e.g., a tangible, non-transitory computer-readable medium loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio data from an audio source (e.g., one or more of the computing devices 106a-c (FIG. 1B)), and/or another one of the playback devices 110. In some embodiments, the operations further include causing the playback device 110a to send audio data to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone, etc.).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some aspects, for example, the state data is shared during predetermined intervals of time (e.g., every 5 seconds, every 10 seconds, every 60 seconds, etc.) among at least a portion of the devices of the media playback system 100, so that one or more of the devices have the most recent data associated with the media playback system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receive and process the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WiFi, Bluetooth, LTE, etc.). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 exclude the network interface 112d altogether and transmits and receives media content and/or other data via another communication path (e.g., the input/output 111).

The audio components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DACs), audio preprocessing components, audio enhancement components, digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omit the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers 112h include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G amplifier, class H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 include a single one of the amplifiers 112h configured to output amplified audio signals to a plurality of the transducers 114. In some other embodiments, the electronics 112 omit the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

By way of illustration, Sonos, Inc. presently offers (or has offered) for sale certain playback devices including, for example, a “SONOS ONE,” “PLAY:1,” “PLAY:3,” “PLAY:5,” “PLAYBAR,” “PLAYBASE,” “CONNECT:AMP,” “CONNECT,” and “SUB.” Other suitable playback devices may additionally or alternatively be used to implement the playback devices of example embodiments disclosed herein. Additionally, one of ordinary skill in the art will appreciate that a playback device is not limited to the examples described herein or to Sonos product offerings. In some embodiments, for example, one or more playback devices 110 comprise wired or wireless headphones (e.g., over-the-ear headphones, on-ear headphones, in-ear earphones, etc.). In other embodiments, one or more of the playback devices 110 comprise a docking station and/or an interface configured to interact with a docking station for personal mobile media playback devices. In certain embodiments, a playback device may be integral to another device or component such as a television, a lighting fixture, or some other device for indoor or outdoor use. In some embodiments, a playback device omits a user interface and/or one or more transducers. For example, FIG. 1D is a block diagram of a playback device 110p comprising the input/output 111 and electronics 112 without the user interface 113 or transducers 114.

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some embodiments, for example, the playback device 110a is a full-range playback device configured to render low frequency, mid-range frequency, and high frequency audio content, and the playback device 110i is a subwoofer configured to render low frequency audio content. In some aspects, the playback device 110a, when bonded with the first playback device, is configured to render only the mid-range and high frequency components of a particular audio content, while the playback device 110i renders the low frequency component of the particular audio content. In some embodiments, the bonded playback device 110q includes additional playback devices and/or another bonded playback device.

c. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some embodiments, the NMD 120a is configured as a media playback device (e.g., one or more of the playback devices 110), and further includes, for example, one or more of the audio components 112g (FIG. 1C), the amplifiers 112h, and/or other playback device components. In certain embodiments, the NMD 120a comprises an Internet of Things (IoT) device such as, for example, a thermostat, alarm panel, fire and/or smoke detector, etc. In some embodiments, the NMD 120a comprises the microphones 115, the voice processing components 124, and only a portion of the components of the electronics 112 described above with respect to FIG. 1C. In some aspects, for example, the NMD 120a includes the processor 112a and the memory 112b (FIG. 1C), while omitting one or more other components of the electronics 112. In some embodiments, the NMD 120a includes additional components (e.g., one or more sensors, cameras, thermometers, barometers, hygrometers, etc.).

In some embodiments, an NMD can be integrated into a playback device. FIG. 1G is a block diagram of a playback device 110r comprising an NMD 120d. The playback device 110r can comprise many or all of the components of the playback device 110a and further include the microphones 115 and voice processing components 124 (FIG. 1F). The playback device 110r optionally includes an integrated control device 130c. The control device 130c can comprise, for example, a user interface (e.g., the user interface 113 of FIG. 1C) configured to receive user input (e.g., touch input, voice input, etc.) without a separate control device. In other embodiments, however, the playback device 110r receives commands from another control device (e.g., the control device 130a of FIG. 1B).

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing components 124 receive and analyze the microphone data to determine whether a voice input is present in the microphone data. The voice input can comprise, for example, an activation word followed by an utterance including a user request. As those of ordinary skill in the art will appreciate, an activation word is a word or other audio cue signifying a user voice input. For instance, in querying the AMAZON VAS, a user might speak the activation word “Alexa.” Other examples include “Ok, Google” for invoking the GOOGLE VAS and “Hey, Siri” for invoking the APPLE VAS.

After detecting the activation word, voice processing components 124 monitor the microphone data for an accompanying user request in the voice input. The user request may include, for example, a command to control a third-party device, such as a thermostat (e.g., NEST thermostat), an illumination device (e.g., a PHILIPS HUE lighting device), or a media playback device (e.g., a SONOS playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home.

d. Suitable Control Devices

FIG. 1H is a partial schematic diagram of the control device 130a (FIGS. 1A and 1B). As used herein, the term “control device” can be used interchangeably with “controller” or “control system.” Among other features, the control device 130a is configured to receive user input related to the media playback system 100 and, in response, cause one or more devices in the media playback system 100 to perform an action(s) or operation(s) corresponding to the user input. In the illustrated embodiment, the control device 130a comprises a smartphone (e.g., an iPhone™, an Android phone, etc.) on which media playback system controller application software is installed. In some embodiments, the control device 130a comprises, for example, a tablet (e.g., an iPad™), a computer (e.g., a laptop computer, a desktop computer, etc.), and/or another suitable device (e.g., a television, an automobile audio head unit, an IoT device, etc.). In certain embodiments, the control device 130a comprises a dedicated controller for the media playback system 100. In other embodiments, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 132a to perform those functions. The software components 132c can comprise applications and/or other executable software configured to facilitate control of the media playback system 100. The memory 132b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11g, 802.11n, 802.11ac, 802.15, 4G, LTE, etc.). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection, etc.) from the control device 130a to one or more of the playback devices 110. The network interface 132d can also transmit and/or receive configuration changes such as, for example, adding/removing one or more playback devices 110 to/from a zone, adding/removing one or more zones to/from a zone group, forming a bonded or consolidated player, separating one or more playback devices from a bonded or consolidated player, among others. Additional description of zones and groups can be found below with respect to FIGS. 1I through 1M.

The user interface 133 is configured to receive user input and can facilitate control of the media playback system 100. The user interface 133 includes media content art 133a (e.g., album art, lyrics, videos, etc.), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year, etc.) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™, an Android phone, etc.). In some embodiments, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some embodiments the control device 130a is configured as an NMD (e.g., one of the NMDs 120), receiving voice commands and other sounds via the one or more microphones 135.

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound, etc.) and/or configured to facilitate filtering of background noise. Moreover, in certain embodiments, the control device 130a is configured to operate as a playback device and an NMD. In other embodiments, however, the control device 130a omits the one or more speakers 134 and/or the one or more microphones 135. For instance, the control device 130a may comprise a device (e.g., a thermostat, an IoT device, a network device, etc.) comprising a portion of the electronics 132 and the user interface 133 (e.g., a touch screen) without any speakers or microphones.

e. Suitable Playback Device Configurations

FIGS. 1I through 1M show example configurations of playback devices in zones and zone groups. Referring first to FIG. 1M, in one example, a single playback device may belong to a zone. For example, the playback device 110g in the second bedroom 101c (FIG. 1A) may belong to Zone C. In some implementations described below, multiple playback devices may be “bonded” to form a “bonded pair” which together form a single zone. For example, the playback device 110m (e.g., a right playback device) can be bonded to the playback device 110l (e.g., a left playback device) to form Zone B. Bonded playback devices may have different playback responsibilities (e.g., channel responsibilities). In another implementation described below, multiple playback devices may be merged to form a single zone. For example, the playback device 110h (e.g., a front playback device) may be merged with the playback device 110i (e.g., a subwoofer), and the playback devices 110j and 110k (e.g., left and right surround speakers, respectively) to form a single Zone D. In another example, the playback devices 110b and 110d can be merged to form a merged group or a zone group 108b. The merged playback devices 110b and 110d may not be specifically assigned different playback responsibilities. That is, the merged playback devices 110h and 110i may, aside from playing audio content in synchrony, each play audio content as they would if they were not merged.

Each zone in the media playback system 100 may be provided for control as a single user interface (UI) entity. For example, Zone A may be provided as a single entity named Master Bathroom. Zone B may be provided as a single entity named Master Bedroom. Zone C may be provided as a single entity named Second Bedroom.

Playback devices that are bonded may have different playback responsibilities, such as responsibilities for certain audio channels. For example, as shown in FIG. 1I, the playback devices 110l and 110m may be bonded so as to produce or enhance a stereo effect of audio content. In this example, the playback device 110l may be configured to play a left channel audio component, while the playback device 110m may be configured to play a right channel audio component. In some implementations, such stereo bonding may be referred to as “pairing.”

Additionally, bonded playback devices may have additional and/or different respective speaker drivers. As shown in FIG. 1J, the playback device 110h named Front may be bonded with the playback device 110i named SUB. The Front device 110h can be configured to render a range of mid to high frequencies and the SUB device 110i can be configured render low frequencies. When unbonded, however, the Front device 110h can be configured render a full range of frequencies. As another example, FIG. 1K shows the Front and SUB devices 110h and 110i further bonded with Left and Right playback devices 110j and 110k, respectively. In some implementations, the Right and Left devices 110j and 102k can be configured to form surround or “satellite” channels of a home theater system. The bonded playback devices 110h, 110i, 110j, and 110k may form a single Zone D (FIG. 1M).

Playback devices that are merged may not have assigned playback responsibilities, and may each render the full range of audio content the respective playback device is capable of. Nevertheless, merged devices may be represented as a single UI entity (i.e., a zone, as discussed above). For instance, the playback devices 110a and 110n the master bathroom have the single UI entity of Zone A. In one embodiment, the playback devices 110a and 110n may each output the full range of audio content each respective playback devices 110a and 110n are capable of, in synchrony.

In some embodiments, an NMD is bonded or merged with another device so as to form a zone. For example, the NMD 120b may be bonded with the playback device 110e, which together form Zone F, named Living Room. In other embodiments, a stand-alone network microphone device may be in a zone by itself. In other embodiments, however, a stand-alone network microphone device may not be associated with a zone. Additional details regarding associating network microphone devices and playback devices as designated or default devices may be found, for example, in subsequently referenced U.S. patent application Ser. No. 15/438,749.

Zones of individual, bonded, and/or merged devices may be grouped to form a zone group. For example, referring to FIG. 1M, Zone A may be grouped with Zone B to form a zone group 108a that includes the two zones. Similarly, Zone G may be grouped with Zone H to form the zone group 108b. As another example, Zone A may be grouped with one or more other Zones C-I. The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in previously referenced U.S. Pat. No. 8,234,395. Playback devices may be dynamically grouped and ungrouped to form new or different groups that synchronously play back audio content.

In various implementations, the zones in an environment may be the default name of a zone within the group or a combination of the names of the zones within a zone group. For example, Zone Group 108b can be assigned a name such as “Dining+Kitchen”, as shown in FIG. 1M. In some embodiments, a zone group may be given a unique name selected by a user.

Certain data may be stored in a memory of a playback device (e.g., the memory 112b of FIG. 1C) as one or more state variables that are periodically updated and used to describe the state of a playback zone, the playback device(s), and/or a zone group associated therewith. The memory may also include the data associated with the state of the other devices of the media system, and shared from time to time among the devices so that one or more of the devices have the most recent data associated with the system.

In some embodiments, the memory may store instances of various variable types associated with the states. Variable instances may be stored with identifiers (e.g., tags) corresponding to type. For example, certain identifiers may be a first type “a1” to identify playback device(s) of a zone, a second type “b1” to identify playback device(s) that may be bonded in the zone, and a third type “c1” to identify a zone group to which the zone may belong. As a related example, identifiers associated with the second bedroom 101c may indicate that the playback device is the only playback device of the Zone C and not in a zone group. Identifiers associated with the Den may indicate that the Den is not grouped with other zones but includes bonded playback devices 110h-110k. Identifiers associated with the Dining Room may indicate that the Dining Room is part of the Dining+Kitchen zone group 108b and that devices 110b and 110d are grouped (FIG. 1L). Identifiers associated with the Kitchen may indicate the same or similar information by virtue of the Kitchen being part of the Dining+Kitchen zone group 108b. Other example zone variables and identifiers are described below.

In yet another example, the memory may store variables or identifiers representing other associations of zones and zone groups, such as identifiers associated with Areas, as shown in FIG. 1M. An area may involve a cluster of zone groups and/or zones not within a zone group. For instance, FIG. 1M shows an Upper Area 109a including Zones A-D and I, and a Lower Area 109b including Zones E-I. In one aspect, an Area may be used to invoke a cluster of zone groups and/or zones that share one or more zones and/or zone groups of another cluster. In another aspect, this differs from a zone group, which does not share a zone with another zone group. Further examples of techniques for implementing Areas may be found, for example, in U.S. application Ser. No. 15/682,506 filed Aug. 21, 2017, and titled “Room Association Based on Name,” and U.S. Pat. No. 8,483,853 filed Sep. 11, 2007, and titled “Controlling and manipulating groupings in a multi-zone media system.” Each of these applications is incorporated herein by reference in its entirety. In some embodiments, the media playback system 100 may not implement Areas, in which case the system may not store variables associated with Areas.

### III. Example Communication Systems

FIG. 1N shows an example communication system 150 that includes example switching circuitry 160 and/or communication circuitry 165 configurations. The communication system 150 may be implemented in, for example, any of a variety of network devices including the playback devices 110. For example, the communication system may be used to communicate with other playback devices or components of a home theater system. Such communication may include instructions, control signals, or messages of any type.

Referring to FIG. 1N, in some embodiments, the communication circuitry 165 is coupled to a common port of the switching circuitry 160 and comprises a front-end circuit 170, a filter 187, a transceiver 190, and a filter 185. Optionally, in some embodiments, the filter 187 and/or the filter 185 may be included in the front-end circuit 170. Further, in some embodiments, the transceiver 190 may be coupled to the one or more processors 112a. The transceiver 190 may be configured for operation in multiple modes (e.g., a UWB mode, a 2.4 GHz WI-FI operation mode, a 5.0 GHz WI-FI operation mode, a 6.0 GHz WI-FI operation mode, and/or a BLUETOOTH operation mode).

In some embodiments, the switching circuitry 160 may be configured to selectively couple one of antennas 155a and 155b to the communication circuitry 165 based on a received control signal. The switching circuitry 160 may be implemented using, for example, one or more switches such as a single-pole, double throw switch (SP2T) switch. In some examples, the control signal may be generated by, for example, the transceiver 190 (e.g., provided via a second control port (CTRL2)). In these examples, the transceiver 190 may comprise one or more network processors that execute instructions stored in a memory (e.g., a memory within the transceiver 190 such as an internal read-only memory (ROM) or an internal read-write memory) that causes the transceiver 190 to perform various operations. An antenna switching program (e.g., that controls the switching circuitry 160 in accordance with the methods described herein) may be stored in the memory and executed by the one or more network processors to cause the transceiver 190 to generate and provide control signals to the switching circuitry 160. In other examples, the control signal for the switching circuitry 160 may be generated by the processor 112a instead of the transceiver 190.

In some embodiments, the front-end circuit 170 may further include a diplexer 175 comprising (i) a first port coupled to a SP2T switch 177, (ii) a second port coupled to a single pole, triple throw (SP3T) switch 178, and (iii) a third port coupled to the switching circuitry 160. The diplexer 175 is configured to separate multiple channels, for example, using one or more filters. More specifically, the diplexer 175 receives a wide-band input from one or more of the antennas 155a and 155b (e.g., via the switching circuitry 160) and provides multiple narrowband outputs. For example, the diplexer 175 may provide a first narrow-band output for a 5 GHz frequency band at the first port to SP2T switch 177 and provide a second narrow-band output for a 2.4 GHz frequency band at the second port to SP3T switch 178.

In some embodiments, SP2T switch 177 comprises a first port coupled to a low noise amplifier (LNA) 180a, a second port coupled to a first transmit port (TX1) of the transceiver 190 (e.g., a 5.0 GHz WI-FI transmit port), and a common port coupled to the diplexer 175. The SP2T switch 177 is configured to selectively couple the common port of the SP2T switch 177 to either the first port or the second port of the SP2T switch 177 based on a received control signal. The control signal may be provided by, for example, the transceiver 190 (e.g., via a first control port (CTRL1) of the transceiver 190).

In some embodiments, SP3T switch 178 comprises a first port coupled to LNA 180b, a second port coupled via BPF 185 to a second transmit port (TX2) of the transceiver 190 (e.g., a 2.4 GHz WI-FI transmit port), a third port coupled to a third transmit port (TX3) of the transceiver 190 (e.g., a BLUETOOTH transmit port), and a common port coupled to the diplexer 175. The SP3T switch 178 is configured to selectively couple the common port of the SP3T switch 178 to either the first port, the second port, or the third port of the SP3T switch 178 based on a received control signal. The control signal may be provided by, for example, the transceiver 190 (e.g., via the first control port (CTRL1) of the transceiver 190).

In some embodiments, each of the LNAs 180a and 180b are further coupled to a first receive port (RX1) (e.g., a 5.0 GHz WI-FI receive port) and a second receive port (RX2) (e.g., a 2.4 GHz WI-FI and/or BLUETOOTH receive port) via filter 187, respectively, of the transceiver 190. In operation, the LNAs 180a and 180b amplify the wireless signals detected by the antennas prior to being received by the transceiver 190 (which may contain additional amplifiers such as additional LNAs) to improve receive sensitivity of the communication system 150. A bypass switch may be coupled in parallel with each of the LNAs 180a and 180b that may be controlled by the transceiver 190 (e.g., via the first control port CTRL1 of the transceiver 190). In operation, the bypass-switch allows the transceiver 190 (or other control circuitry) to close the bypass-switch when the signal received at the transceiver 190 is above a threshold to avoid saturation of one or more amplifiers in the transceiver 190. Thus, the bypass-switch may be open when the signal received at the transceiver 190 has an amplitude below a threshold to improve receive sensitivity and closed when the signal received at the transceiver 190 has an amplitude above the threshold to avoid amplifier saturation.

The filter 187 is desirable in some embodiments to filter out external noise from the environment. In a standard operating environment, there may be a lot of noise near and in the 2.4 GHz band including, for example, noise from cordless home phones, cell phones, etc. In operation, the filter 187 is configured to remove such wireless signal interference in the operating environment. The filter 187 may be designed as a bandpass (BPF) filter, a low-pass filter, and/or a high-pass filter.

The filter 185 may be desirable in some embodiments to reduce out-of-band energy in the output from the transceiver 190 (e.g., from the second transmit port TX2). For example, the output of the transceiver 190 may comprise some energy that is out-of-band when outputting a wireless signal in a channel that is on the edge of the band (e.g., channel 1 or channel 11 in a 2.4 GHz Wi-Fi band). The filter 185 may be designed as a BPF filter, a low-pass filter, and/or a high-pass filter. The filter 185 may, in some implementations, be implemented as a controllable filter (e.g., a controllable BPF). For example, the filter 185 may comprise a BPF and one or more switches that either allow the BPF to be incorporated into the signal path between the transceiver 190 and the SP3T switch 178 or bypassed. In this example, the transceiver 190 may provide a control signal (not shown) to the controllable filter to either have the BPF be included in the signal path or bypassed.

The filters 185 and 187 may be constructed in any of a variety of ways. For instance, the filters 185 and 187 may be constructed using one or more of: a surface acoustic wave (SAW) filter, a crystal filter (e.g., quartz crystal filters), and/or a bulk acoustic wave (BAW) filter. Further, the filter 185 need not be constructed in the same way as the filter 187. For instance, the filter 187 may be implemented as a SAW and the filter 185 may be implemented as another type of filter.

It should be appreciated that the communication system 150 shown in FIG. 1N may be modified in any of a variety of ways without departing from the scope of the present disclosure. For example, the number of one or more components (e.g., antennas, filters, front-end circuits, etc.) may be modified based on the particular implementation. For instance, as shown in FIG. 1N, the number of antennas may be reduced to 1 (shown as antenna 155a) and, as a result of reducing the number of antennas, the switching circuitry 160 may be removed altogether.

Further, in some embodiments, the wireless transceiver 190 may be implemented as a Multi-Input and Multi-Output (MIMO) transceiver (e.g., a 2×2 MIMO transceiver, 3×3 MIMO transceiver, 4×4 MIMO transceiver, etc.) instead of a Single-Input-Single-Output (SISO) transceiver as shown in FIG. 1N. In such an implementation, the front-end circuit 170 may be duplicated for each additional concurrently supported transmit and/or receive signal chain supported by the MIMO transceiver. For instance, the communication circuitry 165 may comprise three front-end circuits 170 for a 3×3 MIMO wireless transceiver (one front-end circuit 170 for each supported transmit and/or receive signal chain). Further, in such MIMO transceiver implementations, the switching circuitry 160 may be removed in some cases. For instance, the switching circuitry 160 may be removed in cases where the number of antennas is equal to the number of supported concurrent transmit and/or receive signal chains (e.g., the switching circuitry 160 may be removed when using two antennas with a 2×2 MIMO transceiver). In other cases, the switching circuitry 160 may still be employed. For example, the communication system 150 may comprise six antennas and a 2×2 MIMO transceiver. In this example, the communication system 150 may still employ switching circuitry 160 to down select from the six antennas to the two antennas that may be coupled to the 2×2 MIMO transceiver at a given time.

### IV. Example Systems and Devices

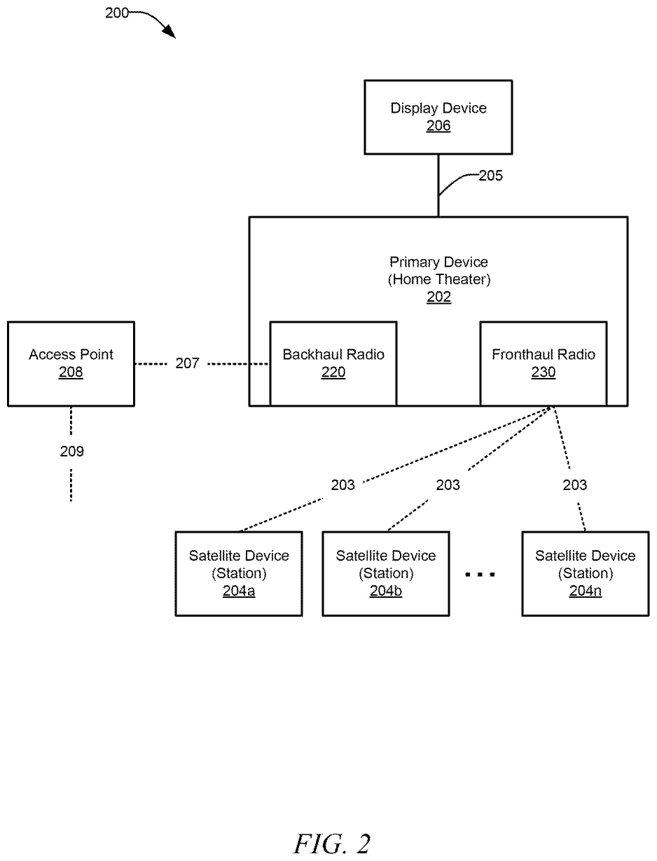

As discussed above, a home theater system may employ a primary device (e.g., a primary playback device) and one or more satellite playback devices. For instance, FIG. 2 illustrates an example of a home theater environment 200. As shown, the home theater environment 200 comprises a display device 206, such as a television or monitor, that displays visual content and outputs audio content (associated with the displayed visual content) via communication link 205 to a primary device 202 (e.g., a soundbar, a smart TV box, a smart TV stick, etc.). The primary device 202 communicates with one or more satellite devices 204 (shown as satellite devices 204a, 204b, . . . 204n) via communication links 203 (e.g., a dedicated fronthaul wireless network connection). Additionally, the primary device 202 communicates with an access point (AP) 208 via a communication link 207 (e.g., a backhaul wireless network connection). The AP 208, in turn, may communicate with other devices, such as a user device (e.g., a smartphone, tablet, laptop, desktop computer, etc.), over the AP network 209. In some instances, the home theater environment 200 may play back audio from a music streaming service. In such instances, the primary device 202 may communicate with one or more cloud servers associated with a music service provider (e.g., via the backhaul network 207 to the AP 208) to obtain the audio content for playback. After receipt of the audio content for playback, the primary device 202 may communicate the audio content (or any portion thereof) to the satellite devices 204 for synchronous playback via the fronthaul network 203. In examples where the primary device 202 is implemented as a soundbar (or otherwise comprises transducers for rendering audio content), the primary device 202 may render the audio content in synchrony with the satellite devices 204.

In some instances, the primary device 202 and the satellite devices 204 may render audio content in lip-synchrony with associated visual content displayed by the display device 206. In such examples, the primary device 202 may receive audio content from the display device 206. For example, the primary device 202 and the display device 206 can include analog and/or digital interfaces that facilitate communicating the audio content (e.g., multi-channel audio content) such as a SPDIF RCA interface, an HDMI interface (e.g., audio return channel (ARC) HDMI interface), an optical interface (e.g., TOSLINK interface), etc.

The primary device 202 may employ a first radio (e.g., a fronthaul radio) 230 for communication of audio to the satellite devices 204 over the fronthaul network 203, and the satellite devices may connect to this fronthaul network to receive communication of the audio for playback from the fronthaul radio 230. The primary device may also employ a second radio (e.g., a backhaul radio) 220 configured to communicate over the backhaul network 207, to connect to the AP 208 so as to provide a communication path to other devices (e.g., user devices to facilitate control of the home theater system and/or cloud server(s) to obtain audio content for streaming). Thus, during the audio playback mode of operation, both the fronthaul radio 230 and the backhaul radio 220 will be powered on and operating.

In some instances, the primary device 202 may source the video content and output the video over the communication link 205 to the display device 206. For example, the primary device 202 may (e.g., using the backhaul radio 220) access a video streaming service (e.g., NETFLIX, AMAZON PRIME, HBO MAX, etc.) over the Internet to obtain video content and corresponding audio content. In this example, the primary device 202 may transmit the video content to the display device 205 (e.g., over the communication link 205) and transmit the audio content to the satellite devices 204 over the fronthaul network 203.

Additionally (or alternatively), the primary device 202 may not directly render any audio content itself. For example, the primary device 202 may omit speakers and/or audio amplifiers and rely on the satellite devices 204 to render all of the audio content. Accordingly, the primary device 202 is not limited in this respect.

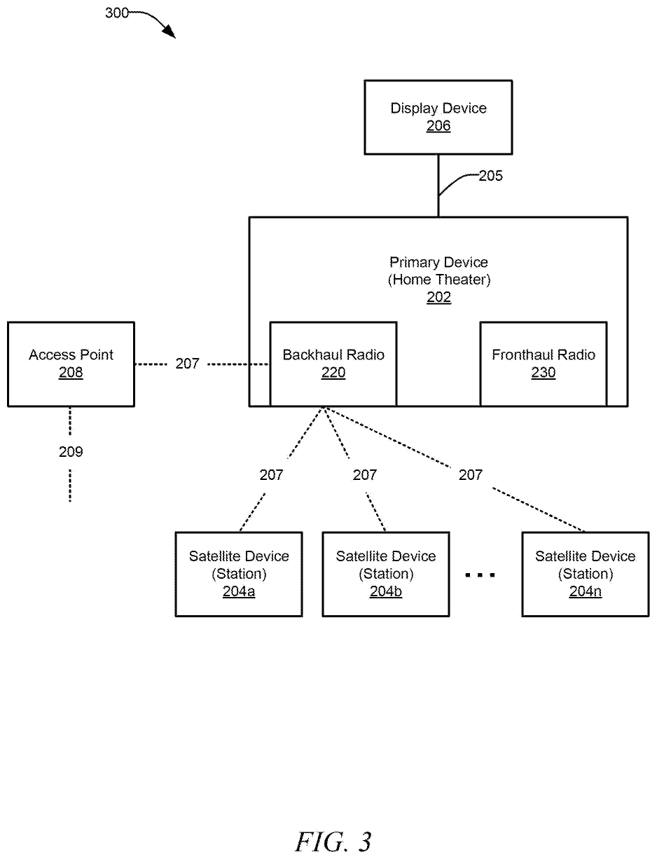

FIG. 3 illustrates another example configuration 300 that includes the home theater primary device, satellite devices, and AP. As previously noted, operation of the fronthaul radio 230 to maintain the fronthaul network 203 consumes power whether or not audio is being played. This power consumption undesirably reduces the power efficiency of the primary device and increases idle power consumption. It can therefore be useful to power off the fronthaul radio 230 when it is not needed, for example when playback has been paused or stopped. In the configuration illustrated in FIG. 3, the fronthaul radio 230 has been powered off and the satellite playback devices 204 are instead connected to the backhaul radio 220 through the backhaul network 207. This network reconfiguration is accomplished by sending message(s) (e.g., a CSA message) to the satellite devices, as will be explained in greater detail below.

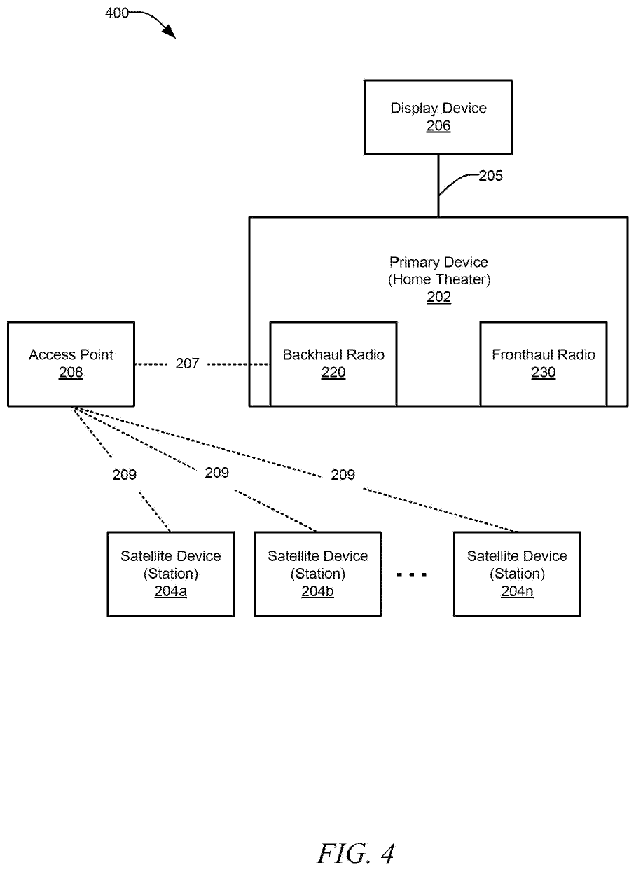

FIG. 4 illustrates another example configuration 400 that includes the home theater primary device, satellite devices, and AP. In this example, both the fronthaul radio 230 and the backhaul radio 220 have been powered down, or otherwise taken out of use, and the satellite playback devices 204 are instead connected to the AP 208 through the AP network 209. This network reconfiguration is also accomplished by sending message(s) (e.g., a CSA message) to the satellite devices, as will be explained in greater detail below.

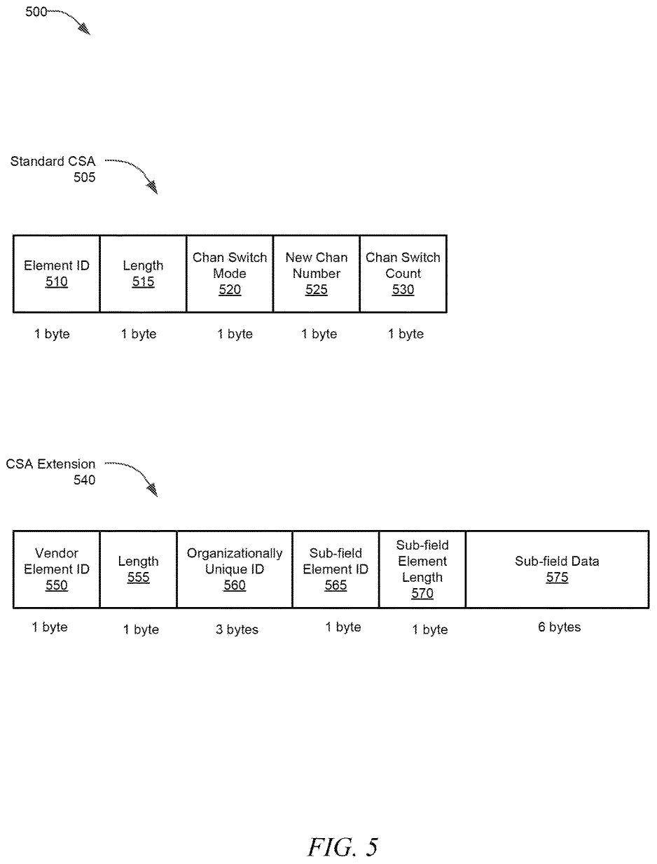

FIG. 5 illustrates a CSA message format 500, configured in accordance with aspects of the disclosed technology. The CSA message format 500 may be transmitted from the primary device 202 to satellite playback devices 204 to instruct them to switch between radios and associated wireless networks, and to provide a channel on the new network to allow for faster acquisition.

The CSA message format 500 is shown to include two parts shown as a standard CSA 505 and a CSA extension 540. As shown, the standard CSA 505 comprises the following fields: (1) element ID 510, (2) length 515, (3) channel switch mode 520, (4) new channel number 525, and (5) channel switch count 530. The extended CSA 540 is appended to the standard CSA 505 and comprises the following fields: (1) vendor element ID 550, (2) length 555, (3) organizationally unique ID (OUID), (4) sub-field element ID 565, (5) sub-field element length 570, and (6) sub-field data 575.

The CSA message format 500 comprises information that may be employed by the satellite playback devices 204 to expedite the transition between radios. For instance, the CSA message format 500 may comprise, as the sub-field data 575 in the CSA extension 540: (i) an indication of an address (e.g., a MAC address) associated with the radio that the satellite playback device is to switch to and/or (ii) an indication of an identifier associated with a network on which the radio that is to be switched to is operating (e.g., Service Set Identifier (SSID) and/or a Basic Service Set Identifier (BSSID)). Additionally, the CSA message format 500 may comprise, as the new channel number 525, an indication of the wireless channel on which the radio that the satellite playback is to switch to is operating. As discussed in more detail below, such information may be employed by a satellite playback device to expedite the transition by performing a targeted scan for the radio that is to be switched to.

It should be appreciated that the particular CSA message format 500 shown in FIG. 5 is only one example implementation and various modifications may be made to the CSA message format 500 without departing from the scope of the present disclosure. For instance, the CSA message format 500 may be broken apart into multiple separate messages (e.g., that may or may not be transmitted in direct succession). Additionally (or alternatively), the fields within the CSA message format 500 may be reordered and/or assigned different byte lengths. Accordingly, the present disclosure is not limited in this respect.

### V. Example Methods

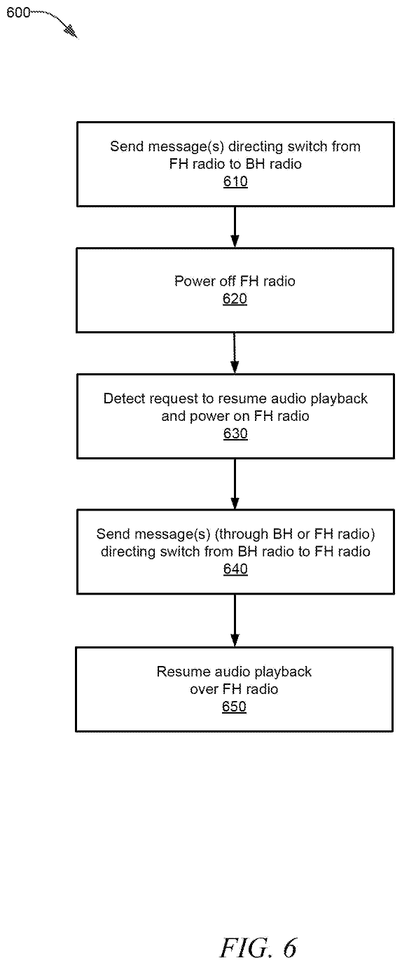

FIG. 6 shows an example embodiment of a method 600 for a primary device to cause satellite playback devices to switch radio links, in accordance with aspects of the disclosed technology. Method 600 can be implemented by the primary device 202 disclosed herein, individually or in combination with any of the computing systems (e.g., computing system(s) 106) and/or user devices (e.g., user devices 130) disclosed herein, or any other computing system(s) and/or user device(s) now known or later developed.

Method 600 begins at block 610, which includes transmitting message(s) from the fronthaul radio of the primary device to be received by one or more satellite playback devices. The message(s) are configured to cause the satellite playback devices to switch connection from the fronthaul radio (e.g., the fronthaul wireless network) to the backhaul radio (e.g., the backhaul wireless network). The message(s) may comprise information that the satellite playback devices may employ to make the switch from the fronthaul radio to the backhaul radio. Examples of such information that may be included in the message(s) include one or more of: (i) an indication of an address associated with the backhaul radio (e.g., a MAC address of the backhaul radio); (ii) an indication of the wireless channel on which the backhaul radio is operating; and/or (iii) an indication of an identifier associated with a network on which the backhaul radio is operating (e.g., Service Set Identifier (SSID) and/or a Basic Service Set Identifier (BSSID)). The message(s) may comprise, for example, one or more CSA messages having a structure and/or contents shown in FIG. 5.

At block 620, method 600 further includes powering off the fronthaul radio of the primary device. The fronthaul radio may be powered off, for example, after a set of one or more conditions have been met. For instance, the fronthaul radio may be powered off after: (1) receipt of an acknowledgement from the one or more satellite playback devices that the message(s) (e.g., a CSA message) were successfully received; or (2) expiration of a period of time after transmission of the message(s). Alternatively, the fronthaul radio may be powered off immediately after transmission of the messages at block 610.

Additionally, in situations where audio is still being played back, playback of audio may be ceased at block 620.

At block 630, method 600 further includes detecting a request to resume audio playback and, in response to that detection, powering on the fronthaul radio. In some embodiments, the request to resume playback may be a wake on wireless packet (e.g., received from a user controller or an AP) or audio received through an HDMI connection.

At block 640, method 600 further includes transmitting message(s) from the backhaul or fronthaul radio of the primary device to be received by one or more of the satellite playback devices. The message(s) are configured to cause the satellite playback devices to switch connection from the backhaul radio (e.g., the backhaul wireless network) to the fronthaul radio (e.g., the fronthaul wireless network). The message(s) may comprise information that the satellite playback devices may employ to make the switch from the backhaul radio to the front radio. Examples of such information that may be included in the message(s) include one or more of: (i) an indication of an address associated with the fronthaul radio (e.g., a MAC address of the backhaul radio); (ii) an indication of the wireless channel on which the fronthaul radio is operating; and/or (iii) an indication of an identifier associated with a network on which the fronthaul radio is operating (e.g., SSID and/or BSSID). The message(s) may comprise, for example, one or more CSA messages having a structure and/or contents shown in FIG. 5.

At block 650, method 600 further includes resuming audio playback by communicating the audio content to the satellite playback device over the fronthaul wireless network using the fronthaul radio.

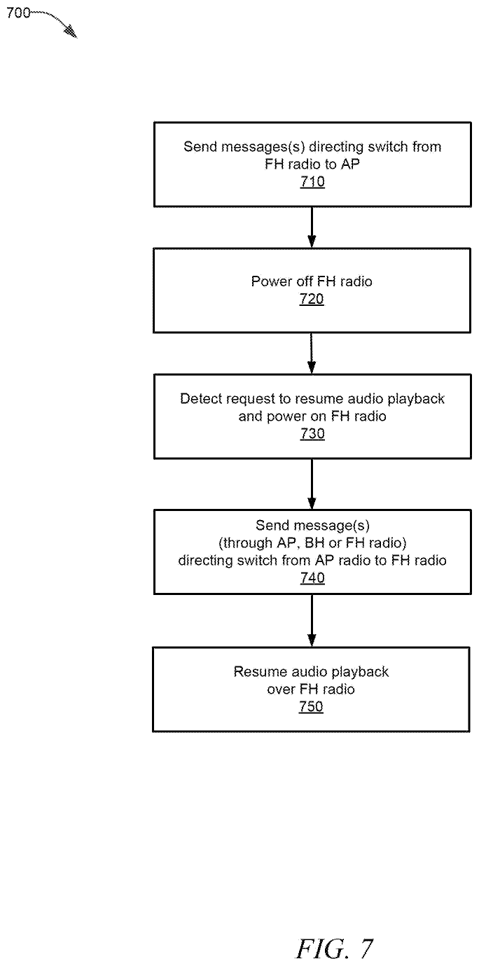

FIG. 7 shows another example embodiment of a method 700 for a primary device to cause satellite playback devices to switch radio links, in accordance with aspects of the disclosed technology. Method 700 can also be implemented by the primary device 202 disclosed herein, individually or in combination with any of the computing systems (e.g., computing system(s) 106) and/or user devices (e.g., user devices 130) disclosed herein, or any other computing system(s) and/or user device(s) now known or later developed.

Method 700 begins at block 710, which includes transmitting message(s) from the fronthaul radio of the primary device to be received by one or more satellite playback devices. The message(s) are configured to cause the satellite playback devices to switch connection from the fronthaul radio (e.g., the fronthaul wireless network) to the AP network. The message(s) may comprise information that the satellite playback devices may employ to make the switch from the fronthaul radio to the AP network. Examples of such information that may be included in the message(s) include one or more of: (i) an indication of an address associated with the a radio (e.g., a MAC address) of the AP; (ii) an indication of the wireless channel on which the AP network is operating; and/or (iii) an identifier associated with the AP network (e.g., SSID and/or BSSID). The message(s) may comprise, for example, one or more CSA messages having a structure and/or contents shown in FIG. 5.

At block 720, method 700 further includes powering off the fronthaul radio. The fronthaul radio may be powered off, for example, after a set of one or more conditions have been met. For instance, the fronthaul radio may be powered off after: (1) receipt of an acknowledgement from the one or more satellite playback devices that the message(s) (e.g., a CSA message) were successfully received; or (2) expiration of a period of time after transmission of the message(s). Alternatively, the fronthaul radio may be powered off immediately after transmission of the message(s) at block 710.

In some embodiments, at block 720, the backhaul radio may also be powered off with the fronthaul radio. The backhaul radio may be powered off, for example, after the same set of one or more conditions employed to turn off the fronthaul radio or a different set of one or more conditions. Alternatively, the backhaul radio may be powered off immediately after transmission of the message(s) at block 710.

At block 730, method 700 further includes detecting a request to resume audio playback and, in response to that detection, powering on the fronthaul radio and the backhaul radio. In some embodiments, the request to resume playback may be a wake on wireless packet received from a user controller or audio received through an HDMI connection.

At block 740, method 700 further includes transmitting message(s) from the backhaul or fronthaul radio of the primary device (or through the AP) to be received by one or more of the satellite playback devices. The message(s) are configured to cause the satellite playback devices to switch connection from the AP network to the fronthaul radio (e.g., the fronthaul wireless network). The message(s) may comprise information that the satellite playback devices may employ to make the switch from the AP network to the fronthaul radio. Examples of such information that may be included in the message(s) include one or more of: (i) an indication of an address associated with the fronthaul radio (e.g., a MAC address of the fronthaul radio); (ii) an indication of the wireless channel on which the fronthaul radio is operating; and/or (iii) an identifier associated with a network on which the fronthaul radio is operating (e.g., SSID and/or BSSID). The message(s) may comprise, for example, one or more CSA messages having a structure and/or contents shown in FIG. 5.

At block 750, method 700 further includes resuming audio playback by communicating the audio content to the satellite playback device over the fronthaul wireless network using the fronthaul radio.

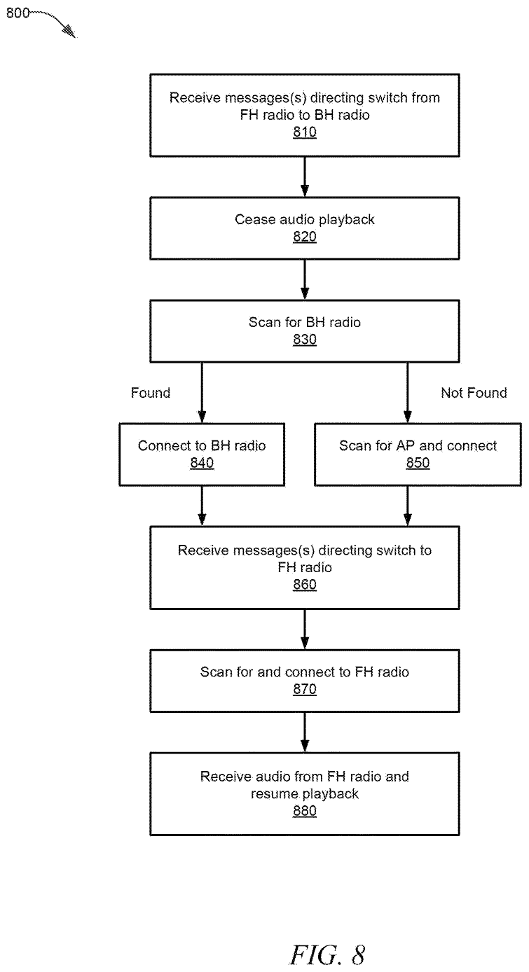

FIG. 8 shows an example embodiment of a method 800 for satellite playback devices to switch radio links, in accordance with aspects of the disclosed technology. Method 800 can be implemented by any of the satellite playback devices disclosed herein, individually or in combination with any of the computing systems (e.g., computing system(s) 106) and/or user devices (e.g., user devices 130) disclosed herein, or any other computing system(s) and/or user device(s) now known or later developed.

Method 800 begins at block 810, which includes receiving message(s) from the fronthaul radio of the primary device. The message(s) are configured to cause the satellite playback device to switch connection from the fronthaul radio (e.g., the fronthaul wireless network) to the backhaul radio. The message(s) may comprise information that may be employed to facilitate the switch from the fronthaul radio (e.g., the fronthaul wireless network) to the backhaul radio (e.g., the backhaul wireless network). For example, the message(s) may comprise (i) an indication of an address of the backhaul radio (e.g., a MAC address of the backhaul radio); (ii) an indication of the wireless channel that may be used to connect to the backhaul radio; and/or (iii) an indication of an identifier of a network associated with the backhaul radio (e.g., SSID, BSSID, etc.). The message(s) may comprise, for example, one or more CSA messages having a structure and/or contents shown in FIG. 5.

At block 820, method 800 further includes ceasing audio playback.

At block 830, method 800 further includes scanning for the backhaul radio. In some instances, the message(s) received at block 810 may comprise information that may be employed to shorten the time that would otherwise be required to locate the backhaul radio. For example, the message(s) may comprise an indication of the network to search for (e.g., BSSID) and a wireless channel on which the backhaul radio is operating. In this example, the scan of the wireless channels for the backhaul radio may be a targeted scan for the network on a set of one or more wireless channels that includes the specified wireless channel indicated in the message(s). For instance, a first scan for the backhaul radio may be a targeted scan just on the channel indicated in the message(s) received at block 810. Should the backhaul radio not be located in a first scan, a second scan (e.g., a broader scan) may be employed that includes at least one channel that was not in the first scan (e.g., in case the backhaul radio has changed the channel on which it is operating).

If the backhaul radio is found, then at block 840, method 800 further includes connecting to the backhaul radio, otherwise, at block 850, method 800 further includes scanning for and connecting to the AP network.

In some instances, If the AP network cannot be found then scanning may continue for any of the fronthaul network, the backhaul network, and the AP network until a network is found.

At block 860, method 800 further includes receiving message(s) configured to cause the satellite playback device to switch connection to the fronthaul radio (e.g., the fronthaul wireless network). The message(s) may comprise information that may be employed to facilitate the switch to the fronthaul radio (e.g., the fronthaul wireless network) from the backhaul radio (e.g., the backhaul wireless network) or the AP (e.g., the AP network). For example, the message(s) may comprise (i) an indication of address of the fronthaul radio (e.g., a MAC address of the fronthaul radio); (ii) an indication of the wireless channel that may be used to connect to the fronthaul radio; and/or (iii) an identifier associated with the fronthaul network (e.g., SSID and/or BSSID). The message(s) may comprise, for example, one or more CSA messages having a structure and/or contents shown in FIG. 5.

At block 870, method 800 further includes scanning for and connecting to the fronthaul radio (e.g., the fronthaul wireless network) from the backhaul wireless network (or the AP network). In some instances, the message(s) received at block 860 may comprise information that may be employed to shorten the time that would otherwise be required to locate the fronthaul radio. For example, the message(s) may comprise an indication of the network to search for (e.g., BSSID) and a wireless channel on which the fronthaul radio is operating. In this example, the scan of the wireless channels for the fronthaul radio may be a targeted scan for the network on a set of one or more wireless channels that includes the specified wireless channel indicated in the message(s). For instance, a first scan for the fronthaul radio may be a targeted scan just on the channel indicated in the message(s) received at block 860. Should the fronthaul radio not be located in a first scan, a second scan (e.g., a broader scan) may be employed that includes at least one channel that was not in the first scan (e.g., in case the fronthaul radio has changed the channel on which it is operating).

At block 880, method 800 further includes receiving audio content from the primary device over the fronthaul wireless network and resuming playback of audio.

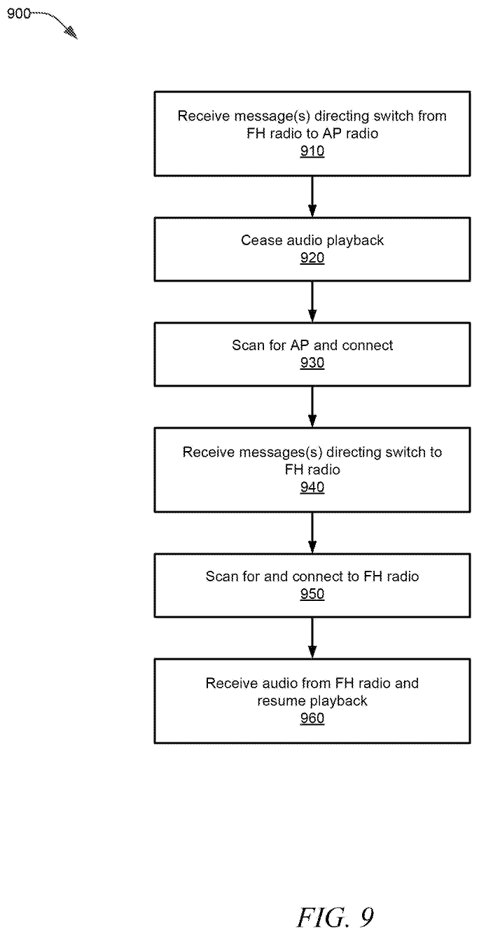

FIG. 9 shows another example embodiment of a method 900 for satellite playback devices to switch radio links, in accordance with aspects of the disclosed technology. Method 900 can also be implemented by any of the satellite playback devices disclosed herein, individually or in combination with any of the computing systems (e.g., computing system(s) 106) and/or user devices (e.g., user devices 130) disclosed herein, or any other computing system(s) and/or user device(s) now known or later developed.

Method 900 begins at block 910, which includes receiving message(s) from the fronthaul radio of the primary device. The message(s) are configured to cause the satellite playback device to switch connection from the fronthaul radio (e.g., the fronthaul wireless network) to the AP network. The message(s) may comprise information that may be employed to facilitate the switch from the fronthaul radio (e.g., the fronthaul wireless network) to the backhaul radio (e.g., the backhaul wireless network). For example, the message(s) may comprise (i) an indication of an address associated with a radio (e.g., MAC address) of the AP; (ii) an indication of the wireless channel on which the AP network is operating; and/or (iii) (iii) an identifier associated with the AP network (e.g., SSID and/or BSSID). The message(s) may comprise, for example, one or more CSA messages having a structure and/or contents shown in FIG. 5.

At block 920, method 900 further includes ceasing audio playback.

At block 930, method 900 further includes scanning for the AP and connecting to the AP network. In some instances, the message(s) received at block 910 may comprise information that may be employed to shorten the time that would otherwise be required to locate the backhaul radio. For example, the message(s) may comprise an indication of the AP network to search for (e.g., BSSID) and a wireless channel on which the AP network is operating. In this example, the scan of the wireless channels for the AP network may be a targeted scan for the network on a set of one or more wireless channels that includes the specified wireless channel indicated in the message(s). For instance, a first scan for the AP network may be a targeted scan just on the channel indicated in the message(s) received at block 810. Should the AP network not be located in a first scan, a second scan (e.g., a broader scan) may be employed that includes at least one channel that was not in the first scan (e.g., in case the AP network has changed the channel on which it is operating).

At block 940, method 900 further includes receiving message(s) configured to cause the satellite playback device to switch connection to the fronthaul radio (e.g., the fronthaul wireless network). The message(s) may comprise information that may be employed to facilitate the switch to the fronthaul radio (e.g., the fronthaul wireless network) from the backhaul radio (e.g., the backhaul wireless network) or the AP (e.g., the AP network). For example, the message(s) may comprise (i) an indication of address of the fronthaul radio (e.g., a MAC address of the fronthaul radio); (ii) an indication of the wireless channel that may be used to connect to the fronthaul radio; and/or (iii) an identifier associated with the fronthaul network (e.g., SSID and/or BSSID). The message(s) may comprise, for example, one or more CSA messages having a structure and/or contents shown in FIG. 5.

At block 950, method 900 further includes scanning for and connecting to the fronthaul radio (e.g., the fronthaul wireless network) from the AP network. In some instances, the message(s) received at block 940 may comprise information that may be employed to shorten the time that would otherwise be required to locate the fronthaul radio. For example, the message(s) may comprise an indication of the network to search for (e.g., BSSID) and a wireless channel on which the fronthaul radio is operating. In this example, the scan of the wireless channels for the fronthaul radio may be a targeted scan for the network on a set of one or more wireless channels that includes the specified wireless channel indicated in the message(s). For instance, a first scan for the fronthaul radio may be a targeted scan just on the channel indicated in the message(s) received at block 940. Should the fronthaul radio not be located in a first scan, a second scan (e.g., a broader scan) may be employed that includes at least one channel that was not in the first scan (e.g., in case the fronthaul radio has changed the channel on which it is operating).

At block 960, method 900 further includes receiving audio content from the primary device over the fronthaul wireless network and resuming playback of audio.

It should be appreciated that the blocks shown in methods described herein with respect to FIGS. 6-9 may be performed in a different order than shown without departing from the scope of the present disclosure. For example, one or more blocks shown in the methods may be performed in a different order or omitted altogether. For instance, with respect to FIG. 9, block 920 of ceasing audio playback may occur before block 910 of receiving message(s) directing the switch from the fronthaul radio to the AP radio in some embodiments. Accordingly, the disclosure is not limited in this respect.

### VI. Conclusion

The above discussions relating to playback devices, controller devices, playback zone configurations, and media content sources provide only some examples of operating environments within which functions and methods described below may be implemented. Other operating environments and configurations of media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways) to implement such systems, methods, apparatus, and/or articles of manufacture.

It should be appreciated that references to transmitting information to particular components, devices, and/or systems herein should be understood to include transmitting information (e.g., messages, requests, responses) indirectly or directly to the particular components, devices, and/or systems. Thus, the information being transmitted to the particular components, devices, and/or systems may pass through any number of intermediary components, devices, and/or systems prior to reaching its destination. For example, a control device may transmit information to a playback device by first transmitting the information to a computing system that, in turn, transmits the information to the playback device. Further, modifications may be made to the information by the intermediary components, devices, and/or systems. For example, intermediary components, devices, and/or systems may modify a portion of the information, reformat the information, and/or incorporate additional information.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

### VII. Example Features

(Feature 1) A playback device comprising: a first radio configured to communicate over a first wireless network; a second radio configured to communicate over a second wireless network; at least one processor; at least one non-transitory computer-readable medium; and program instructions stored on the non-transitory computer-readable medium that are executable by the at least one processor such that the playback device is configured to play back audio content in synchrony with a satellite playback device at least in part by communicating the audio content to the satellite playback device over the first wireless network; and transmit a Channel Switch Announcement (CSA) message to the satellite playback device over the first wireless network, the CSA message configured to cause the satellite playback device to switch connection from the first wireless network to the second wireless network.

(Feature 2) The playback device of feature 1, wherein the at least one non-transitory computer-readable medium further comprises program instructions that are executable by the at least one processor such that the playback device is configured to: after transmission of the CSA message, cease playback of the audio content; and power off the first wireless radio.

(Feature 3) The playback device of feature 1, wherein the CSA message includes a Media Access Control (MAC) address associated with the second radio and a channel number for operation within the second wireless network.

(Feature 4) The playback device of feature 1, wherein the CSA message is a first CSA message and the at least one non-transitory computer-readable medium further comprises program instructions that are executable by the at least one processor such that the playback device is configured to: detect a request to resume playback of the audio content; power on the first wireless radio; and transmit a second CSA message to the satellite playback device over the second wireless network, the second CSA message configured to cause the satellite playback device to switch connection from the second wireless network to the first wireless network.

(Feature 5) The playback device of feature 4, wherein the at least one non-transitory computer-readable medium further comprises program instructions that are executable by the at least one processor such that the playback device is configured to: after transmission of the second CSA message, resume playback of the audio content by communicating the audio content to the satellite playback device over the first wireless network.

(Feature 6) The playback device of feature 4, wherein the request to resume playback of the audio content is received from a user control device.

(Feature 7) The playback device of feature 6, wherein the user control device is a smartphone, or a control device connected to the playback device over a High-Definition Multimedia Interface (HDMI) connection.

(Feature 8) The playback device of feature 1, wherein the playback device is a soundbar.

(Feature 9) The playback device of feature 1, wherein the playback device is a smart television.

(Feature 10) The playback device of feature 1, wherein the satellite playback device is a speaker.

(Feature 11) A playback device comprising: a first radio configured to communicate over a first wireless network; a second radio configured to communicate over a second wireless network; at least one processor; at least one non-transitory computer-readable medium; and program instructions stored on the non-transitory computer-readable medium that are executable by the at least one processor such that the playback device is configured to play back audio content in synchrony with a satellite playback device at least in part by communicating the audio content to the satellite playback device over the first wireless network; and transmit a Channel Switch Announcement (CSA) message to the satellite playback device over the first wireless network, the CSA message configured to cause the satellite playback device to switch connection from the first wireless network to a third wireless network, the third wireless network associated with a WIFI Access Point (AP).

(Feature 12) The playback device of feature 1, wherein the at least one non-transitory computer-readable medium further comprises program instructions that are executable by the at least one processor such that the playback device is configured to: after transmission of the CSA message, cease playback of the audio content; power off the first wireless radio; and power off the second wireless radio.

(Feature 13) The playback device of feature 11, wherein the CSA message includes a Media Access Control (MAC) address associated with the WIFI AP and a channel number for operation within the third wireless network.

(Feature 14) The playback device of feature 11, wherein the CSA message is a first CSA message and the at least one non-transitory computer-readable medium further comprises program instructions that are executable by the at least one processor such that the playback device is configured to: detect a request to resume playback of the audio content; power on the first wireless radio; and transmit a second CSA message to the satellite playback device through the WIFI AP, over the third wireless network, the second CSA message configured to direct the satellite playback device to switch connection from the third wireless network to the first wireless network.

(Feature 15) The playback device of feature 14, wherein the at least one non-transitory computer-readable medium further comprises program instructions that are executable by the at least one processor such that the playback device is configured to: after transmission of the second CSA message, resume playback of the audio content by communicating the audio content to the satellite playback device over the first wireless network.

(Feature 16) The playback device of feature 14, wherein the request to resume playback of the audio content is received from a user control device.

(Feature 17) The playback device of feature 16, wherein the user control device is a smartphone, or a control device connected to the playback device over a High-Definition Multimedia Interface (HDMI) connection.

(Feature 18) The playback device of feature 11, wherein the playback device is a soundbar.

(Feature 19) The playback device of feature 11, wherein the playback device is a smart television.

(Feature 20) The playback device of feature 11, wherein the satellite playback device is a speaker.

(Feature 21) A first playback device comprising: a wireless radio; at least one processor; at least one non-transitory computer-readable medium; and program instructions stored on the non-transitory computer-readable medium that are executable by the at least one processor such that the first playback device is configured to connect, through the wireless radio, to a second playback device over a first wireless network; receive audio content from the second playback device over the first wireless network; play back the audio content in synchrony with the second playback device; and receive a Channel Switch Announcement (CSA) message from the second playback device over the first wireless network, the CSA message configured to direct the first playback device to switch connection from the first wireless network to a second wireless network.

(Feature 22) The first playback device of feature 21, wherein the at least one non-transitory computer-readable medium further comprises program instructions that are executable by the at least one processor such that the first playback device is configured to: after receipt of the CSA message, cease playback of the audio content.

(Feature 23) The first playback device of feature 21, wherein the CSA message includes a Media Access Control (MAC) address associated with the second wireless network and a channel number for operation within the second wireless network.

(Feature 24) The first playback device of feature 21, wherein the CSA message is a first CSA message and the at least one non-transitory computer-readable medium further comprises program instructions that are executable by the at least one processor such that the first playback device is configured to: receive a second CSA message over the second wireless network, the second CSA message configured to direct the first playback device to switch connection from the second wireless network to the first wireless network.

(Feature 25) The first playback device of feature 24, wherein the at least one non-transitory computer-readable medium further comprises program instructions that are executable by the at least one processor such that the first playback device is configured to: after receipt of the second CSA message, reconnect, through the wireless radio, to the second playback device over the first wireless network; receive audio content from the second playback device over the first wireless network; and resume playback of the audio content.

(Feature 26) The first playback device of feature 21, wherein the first playback device is a speaker, and the second playback device is one of a soundbar or a smart television.

(Feature 27) A first playback device comprising: a wireless radio; at least one processor; at least one non-transitory computer-readable medium; and program instructions stored on the non-transitory computer-readable medium that are executable by the at least one processor such that the first playback device is configured to connect, through the wireless radio, to a second playback device over a first wireless network; receive audio content from the second playback device over the first wireless network; play back the audio content in synchrony with the second playback device; and receive a Channel Switch Announcement (CSA) message from the second playback device over the first wireless network, the CSA message configured to direct the first playback device to switch connection from the first wireless network to a third wireless network, the third wireless network associated with a WIFI Access Point (AP).

(Feature 28) The first playback device of feature 27, wherein the at least one non-transitory computer-readable medium further comprises program instructions that are executable by the at least one processor such that the first playback device is configured to: after receipt of the CSA message, cease playback of the audio content.

(Feature 29) The first playback device of feature 27, wherein the CSA message includes a Media Access Control (MAC) address associated with the WIFI AP and a channel number for operation within the third wireless network.

(Feature 30) The first playback device of feature 27, wherein the CSA message is a first CSA message and the at least one non-transitory computer-readable medium further comprises program instructions that are executable by the at least one processor such that the first playback device is configured to: receive a second CSA message over the third wireless network, the second CSA message configured to direct the first playback device to switch connection from the third wireless network to the first wireless network.

(Feature 31) The first playback device of feature 30, wherein the at least one non-transitory computer-readable medium further comprises program instructions that are executable by the at least one processor such that the first playback device is configured to: after receipt of the second CSA message, reconnect, through the wireless radio, to the second playback device over the first wireless network; receive audio content from the second playback device over the first wireless network; and resume playback of the audio content.

(Feature 32) The first playback device of feature 27, wherein the first playback device is a speaker, and the second playback device is one of a soundbar or a smart television.

(Feature 33) A playback device comprising: a first radio configured to communicate over a first wireless network; a second radio configured to communicate over a second wireless network; at least one processor configured to cause the playback device to: play back audio content in synchrony with a second playback device at least in part by communicating the audio content to the second playback device over the first wireless network; and transmit a Channel Switch Announcement (CSA) message to the second playback device over the first wireless network, the CSA message configured to cause the second playback device to switch connection from the first wireless network to a different wireless network, wherein the different wireless network is one of: the second wireless network over which the second radio is configured to communicate; and a third wireless network associated with a WiFi Access Point (AP).

(Feature 34) The playback device of feature 33, wherein the at least one processor is configured to: after transmission of the CSA message, cease playback of the audio content; and power off the first radio.

(Feature 35) The playback device of one of features 33 or 34, wherein the different network is the second wireless network, and wherein the CSA message includes a Media Access Control (MAC) address associated with the second radio and a channel number for operation within the second wireless network.

(Feature 36) The playback device of any preceding feature, wherein: the different network is the second wireless network, the CSA message is a first CSA message and the at least one processor is configured to cause the playback device to: detect a request to resume playback of the audio content; power on the first radio; and transmit a second CSA message to the second playback device over the second wireless network, the second CSA message configured to cause the second playback device to switch connection from the second wireless network to the first wireless network.

(Feature 37) The playback device of feature 33 or 34, wherein the different wireless network is the third wireless network.

(Feature 38) The playback device of feature 37, wherein the at least one processor is configured to cause the playback device to power off the second radio.

(Feature 39) The playback device of feature 37 or 38, wherein the CSA message includes a Media Access Control (MAC) address associated with the WiFi AP and a channel number for operation within the third wireless network.

(Feature 40) The playback device of one of features 37 to 39, wherein the CSA message is a first CSA message and the at least one processor is configured to cause the playback device to: detect a request to resume playback of the audio content; power on the first radio; and transmit a second CSA message to the second playback device through the WiFi AP, over the third wireless network, the second CSA message configured to direct the second playback device to switch connection from the third wireless network to the first wireless network.

(Feature 41) The playback device of feature 36 or 40, wherein the at least one processor is further configured to cause the playback device to, after transmission of the second CSA message, resume playback of the audio content by communicating the audio content to the second playback device over the first wireless network.

(Feature 42) The playback device of feature 36, 40, or 41, wherein the request to resume playback of the audio content is received from a user control device.

(Feature 43) The playback device of feature 42, wherein the user control device is a smartphone, or a control device connected to the playback device over a High-Definition Multimedia Interface (HDMI) connection.

(Feature 44) The playback device of any preceding feature, wherein the playback device is a soundbar, and wherein the second playback device is a satellite playback device.

(Feature 45) The playback device of any preceding feature, wherein the playback device is a smart television.

(Feature 46) The playback device of any preceding feature, wherein the satellite playback device is a speaker.

(Feature 47) A playback device comprising: a wireless radio; at least one processor configured to cause the playback device to: connect, through the wireless radio, to a second playback device over a first wireless network; receive audio content from the second playback device over the first wireless network; play back the audio content in synchrony with the second playback device; receive, over the first wireless network from the second playback device, a Channel Switch Announcement (CSA) message configured to direct the first playback device to switch connection from the first wireless network to a second wireless network; and in response to receiving the CSA message, switching connection from the first wireless network to the different wireless network, wherein the different wireless network is one of: a second wireless network over which a second radio of the second playback device is configured to communicate; and a third wireless network associated with a WiFi Access Point (AP).

(Feature 48) The playback device of feature 47, wherein the at least one processor is configured to cause the playback device to: after receipt of the CSA message, cease playback of the audio content.

(Feature 49) The playback device of one of features 47 or 48, wherein the CSA message is a first CSA message and the at least one processor is configured to cause the playback device to, after receiving, over the different wireless network, a second CSA message configured to direct the playback device to switch connection from the different wireless network to the first wireless network: reconnect, through the wireless radio, to the second playback device over the first wireless network; receive audio content from the second playback device over the first wireless network; and resume playback of the audio content.

(Feature 50) The playback device of one of features 47 to 49, wherein the different wireless network is the second wireless network, and wherein CSA message includes a Media Access Control (MAC) address associated with the second wireless network and a channel number for operation within the second wireless network, wherein switching to the different network comprises switching to the second wireless network.

(Feature 51) The playback device of one of features 47 to 50, wherein: the different wireless network is the third wireless network, and the CSA message includes a Media Access Control (MAC) address associated with the WiFi AP and a channel number for operation within the third wireless network, wherein switching to the different network comprises switching to the third wireless network.

(Feature 52) The playback device of one of features 47 to 51, wherein the first playback device is a speaker, and the second playback device is one of a soundbar or a smart television.

(Feature 53) A system comprising a playback device according to one of features 33 to 46 and at least one playback device according to one of features 48 to 52.

1-21. (canceled)

22. A playback device comprising:
a first radio configured to communicate over a first wireless network;
a second radio configured to communicate over a second wireless network;
at least one processor;
at least one non-transitory computer-readable medium; and
program instructions stored on the non-transitory computer-readable medium that are executable by the at least one processor such that the playback device is configured to
play back audio content in synchrony with a satellite playback device at least in part by communicating the audio content to the satellite playback device over the first wireless network; and
transmit a Channel Switch Announcement (CSA) message to the satellite playback device over the first wireless network, the CSA message configured to cause the satellite playback device to switch connection from the first wireless network to the second wireless network.

23. The playback device of claim 22, wherein the at least one non-transitory computer-readable medium further comprises program instructions that are executable by the at least one processor such that the playback device is configured to:
after transmission of the CSA message, cease playback of the audio content; and
power off the first radio.

24. The playback device of claim 22, wherein the CSA message includes a Media Access Control (MAC) address associated with the second radio and a channel number for operation within the second wireless network.

25. The playback device of claim 22, wherein the CSA message is a first CSA message and the at least one non-transitory computer-readable medium further comprises program instructions that are executable by the at least one processor such that the playback device is configured to:
detect a request to resume playback of the audio content;
power on the first radio; and
transmit a second CSA message to the satellite playback device over the second wireless network, the second CSA message configured to cause the satellite playback device to switch connection from the second wireless network to the first wireless network.

26. The playback device of claim 25, wherein the at least one non-transitory computer-readable medium further comprises program instructions that are executable by the at least one processor such that the playback device is configured to:
after transmission of the second CSA message, resume playback of the audio content by communicating the audio content to the satellite playback device over the first wireless network.

27. The playback device of claim 25, wherein the request to resume playback of the audio content is received from a user control device.

28. The playback device of claim 27, wherein the user control device is a smartphone, or a control device connected to the playback device over a High-Definition Multimedia Interface (HDMI) connection.

29. The playback device of claim 22, wherein the playback device is one of a soundbar, a smart television, or a speaker.

30. A playback device comprising:
a first radio configured to communicate over a first wireless network;
a second radio configured to communicate over a second wireless network;
at least one processor;
at least one non-transitory computer-readable medium; and
program instructions stored on the non-transitory computer-readable medium that are executable by the at least one processor such that the playback device is configured to
play back audio content in synchrony with a satellite playback device at least in part by communicating the audio content to the satellite playback device over the first wireless network; and
transmit a Channel Switch Announcement (CSA) message to the satellite playback device over the first wireless network, the CSA message configured to cause the satellite playback device to switch connection from the first wireless network to a third wireless network, the third wireless network associated with a WiFi Access Point (AP).

31. The playback device of claim 30, wherein the at least one non-transitory computer-readable medium further comprises program instructions that are executable by the at least one processor such that the playback device is configured to:
after transmission of the CSA message, cease playback of the audio content;
power off the first radio; and
power off the second radio.

32. The playback device of claim 30, wherein the CSA message includes a Media Access Control (MAC) address associated with the WiFi AP and a channel number for operation within the third wireless network.

33. The playback device of claim 30, wherein the CSA message is a first CSA message and the at least one non-transitory computer-readable medium further comprises program instructions that are executable by the at least one processor such that the playback device is configured to:
detect a request to resume playback of the audio content;
power on the first radio; and
transmit a second CSA message to the satellite playback device through the WiFi AP, over the third wireless network, the second CSA message configured to direct the satellite playback device to switch connection from the third wireless network to the first wireless network.

34. The playback device of claim 30, wherein the request to resume playback of the audio content is received from a user control device and the playback device is one of a soundbar, a smart television, or a speaker.

35. A first playback device comprising:
a wireless radio;
at least one processor;
at least one non-transitory computer-readable medium; and
program instructions stored on the non-transitory computer-readable medium that are executable by the at least one processor such that the first playback device is configured to
connect, through the wireless radio, to a second playback device over a first wireless network;
receive audio content from the second playback device over the first wireless network;
play back the audio content in synchrony with the second playback device; and
receive a Channel Switch Announcement (CSA) message from the second playback device over the first wireless network, the CSA message configured to direct the first playback device to switch connection from the first wireless network to a second wireless network.

36. The first playback device of claim 35, wherein the second wireless network is associated with a WiFi Access Point (AP).

37. The first playback device of claim 35, wherein the at least one non-transitory computer-readable medium further comprises program instructions that are executable by the at least one processor such that the first playback device is configured to:
after receipt of the CSA message, cease playback of the audio content.

38. The first playback device of claim 35, wherein the CSA message includes a Media Access Control (MAC) address associated with the second wireless network and a channel number for operation within the second wireless network.

39. The first playback device of claim 35, wherein the CSA message is a first CSA message and the at least one non-transitory computer-readable medium further comprises program instructions that are executable by the at least one processor such that the first playback device is configured to:
receive a second CSA message over the second wireless network, the second CSA message configured to direct the first playback device to switch connection from the second wireless network to the first wireless network.

40. The first playback device of claim 39, wherein the at least one non-transitory computer-readable medium further comprises program instructions that are executable by the at least one processor such that the first playback device is configured to:
after receipt of the second CSA message, reconnect, through the wireless radio, to the second playback device over the first wireless network;
receive audio content from the second playback device over the first wireless network;
and
resume playback of the audio content.

41. The first playback device of claim 35, wherein the first playback device is a speaker, and the second playback device is one of a soundbar or a smart television.
